(19) United States
(12) Patent Application Publication
(10) Pub. No.: US 2007/0013467 A1
(43) Pub. Date: Jan. 18, 2007

(54) Relay and Method for the Production Thereof

(76) Inventor: Rudolf Mikl, Arbesthal (AT)

Correspondence Address: BARLEY SNYDER, LLC, 1000 WESTLAKES DRIVE, SUITE 275, BERWYN, PA, 19312, US

(21) Appl. No.: 11/457,226

(22) Filed: Jul. 13, 2006

(30) Foreign Application Priority Data
Jul. 16, 2005 (DE) 102005033348.6

(51) Int. Cl. H01H 51/22

(52) U.S. Cl. 335/78

(57) ABSTRACT

A relay comprises a main body containing first, second, and third contact carriers, connection pins, and a magnetic system. The first, second, and third contact carriers are provided with contacts. Each of the first, second, and third contact carriers is connected to at least one of the connection pins. The connection pins protrude outward from a connection side of the relay. The magnetic system is mechanically coupled to at least one of the first, second and third contact carriers for changing switching states of the contacts. An insertion member having a plurality of webs is arranged adjacent to the connection side. The insertion member is introduced into the main body from an assembly side adjoining the connection side such that one of the webs of the insertion member is positioned between each of the first, second, and third carrier contacts.

### FIELD OF THE INVENTION

The invention relates to a relay and to a method of production of a relay.

### BACKGROUND OF THE INVENTION

A relay typically comprises a plurality of contact carriers with contacts, connection pins and a magnetic system or other drive system. At least one contact carrier is elastically deformable or may be moved in another manner between at least two different positions and is driven by the magnetic system in order to open or close a circuit while cooperating with a contact of another contact carrier. The contact carriers may be connected to external circuits via the connection pins.

In a typical relay, a main body consisting of an insulating material holds the contact carriers, the connection pins, and the magnetic system. The main body is positioned with the contact carriers and the magnetic system in a hood for protection against environmental conditions. The hood typically only has one opening through which the main body is inserted into the hood and from which the connection pins protrude outwards. In order to seal the relay against fluids, the opening may be sealed with a layer of adhesive.

During the service life of the relay, deposits are formed in the interior thereof, mainly due to erosion of the contacts. Leakage currents are able to flow via these deposits. In order to avoid these currents or at least to minimize them, leakage paths of a minimum length are provided between the contacts. These leakage paths, however, make it difficult to miniaturize the relay.

A greatly miniaturized relay having a housing width of only 5 mm has already been produced, wherein the connection pins are cast into the main body. However, casting the connection pins is disadvantageous in that this requires an expensive casting mold and involves using a relatively large amount of molding compound. Both factors have a direct adverse effect on the production costs of the relay.

### BRIEF SUMMARY OF THE INVENTION

It is an object of the invention is to provide a relay which is simpler and more economic to produce and to provide a method for simpler and more economic production of a relay.

This and other objects are achieved by a relay comprising a main body containing first, second, and third contact carriers, connection pins, and a magnetic system. The first, second, and third contact carriers are provided with contacts. Each of the first, second, and third contact carriers is connected to at least one of the connection pins. The connection pins protrude outward from a connection side of the relay. The magnetic system is mechanically coupled to at least one of the first, second and third contact carriers for changing switching states of the contacts. An insertion member is arranged adjacent to the connection side. The insertion member has a plurality of webs. One of the webs of the insertion member is positioned between each of the first, second, and third carrier contacts.

This and other objects are further achieved by a method for producing a relay comprising the steps of: inserting a magnetic system into a main body; inserting first, second, and third contact carriers into the main body wherein the first, second, and third contact carriers are provided with contacts; inserting connection pins into the main body so that the connection pins protrude outward from a connection side of the relay wherein each of the first, second, and third contact carriers is connected to at least one of the connection pins; and introducing an insertion member into the main body from an assembly side adjoining the connection side so that the insertion member has webs positioned between each of the first, second, and third carrier contacts.

### BRIEF DESCRIPTION OF THE DRAWINGS

FIG. 1 is a schematic axonometric illustration of a first side of a relay according to a first embodiment of the invention;

FIG. 2 is a schematic axonometric illustration of a second side of a relay according to the first embodiment of the invention;

FIG. 3 is a schematic axonometric illustration of a third side of a relay according to the first embodiment of the invention;

FIG. 4 is a schematic axonometric illustration of a first side of an insertion member of the relay of FIG. 1;

FIG. 5 is a schematic axonometric illustration of a second side of the insertion member of the relay of FIG. 1;

FIG. 6 is a first schematic top view of a second embodiment of a relay according to the invention;

FIG. 7 is a schematic axonometric illustration of a first side of the relay according to the second embodiment of the invention;

FIG. 8 is a schematic axonometric illustration of a second side of the relay according to the second embodiment of the invention;

FIG. 9 is a schematic axonometric illustration of a third side of the relay according to the second embodiment of the invention;

FIG. 10 is a second schematic top view of the second embodiment of a relay according to the invention;

FIG. 11 is a third schematic top view of the second embodiment of a relay according to the invention; and

FIG. 12 is a schematic flow chart of a method of producing the relay according to an embodiment of the invention.

### DETAILED DESCRIPTION OF THE INVENTION

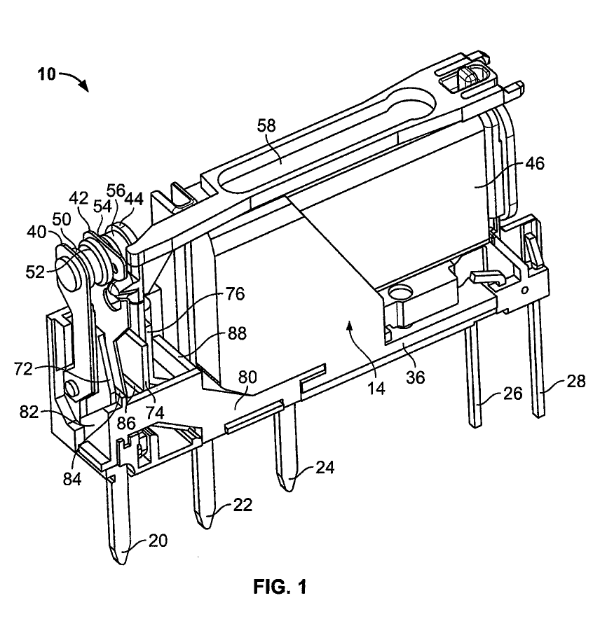

FIGS. 1-3 show a relay 10 according to a first embodiment of the invention. As shown in FIGS. 1-3, the relay 10 comprises a main body 36 inserted into an opening of a hood 12. The main body 36 holds first, second, and third contact carriers 40, 42, 44, respectively, and a magnetic system 46. In the illustrated embodiment, the second contact carrier 42 is illustrated as the middle contact carrier. At least the second contact carrier 42 is elastically defornable. Each of the first, second, and third contact carriers 40, 42, 44 has one or more contacts 50, 52, 54, 56. For example, in the illustrated embodiment, the first contact carrier 40 has the contact 50, the second contact carrier has the contacts 52, 54, and the third contact carrier has the contact 56. Each of the first, second, and third contact carriers 40, 42, 44 is electrically connected to connection pins 20, 22, 24, respectively.

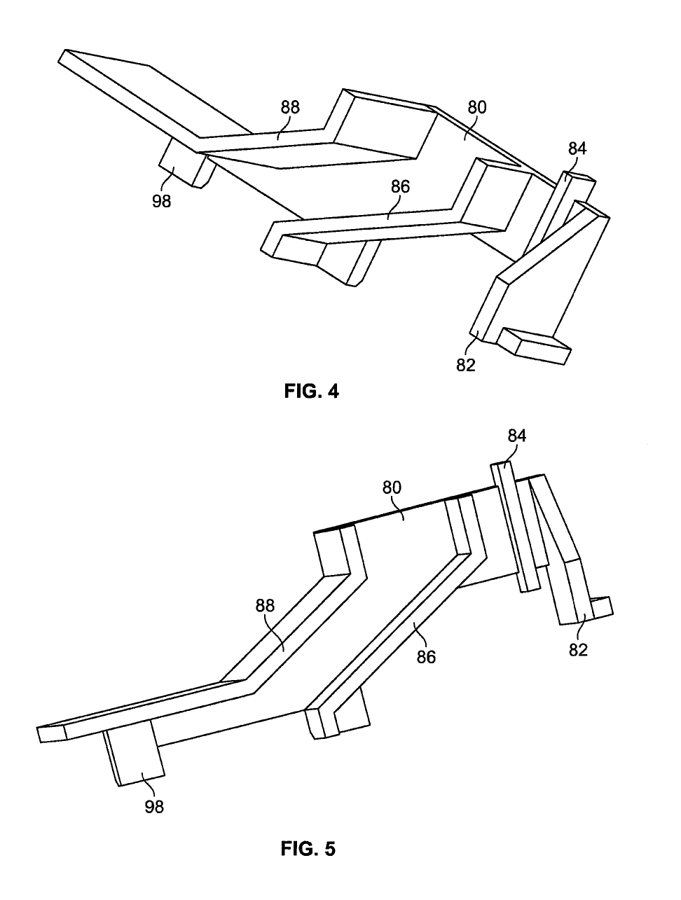

The main body 36 includes webs 72, 74, 76 arranged between the first, second, and third contact carriers 40, 42, 44 and between the third contact carrier 44 and the magnetic system 46. The webs 72, 74, 76 extend up to a connection side 30 of the relay 10. An insertion member 80 with webs 82, 84, 86, 88 is inserted into the main body 36, as shown in FIGS. 4-5. The webs 82, 84, 86, 88 of the insertion member 80 engage (at least to some extent) between the first, second, and third contact carriers 40, 42, 44 and the magnetic system 46, as shown in FIGS. 1-3.

The connection side 30 is provided with a plurality of slots 90, 92, 94 that extend from an assembly side 14. The connection side 30 faces, for example, a printed circuit board. The connection pins 20, 22, 24 protrude from the connection side 30 through the slots 90, 92, 94, respectively. The slots 90, 92, 94 are only partly filled or sealed by the connection pins 20, 22, 24, but are completely sealed by ends, facing the connection side 30, of the webs 82, 86 of the insertion member 80 and by a tongue 98 on the insertion member 80.

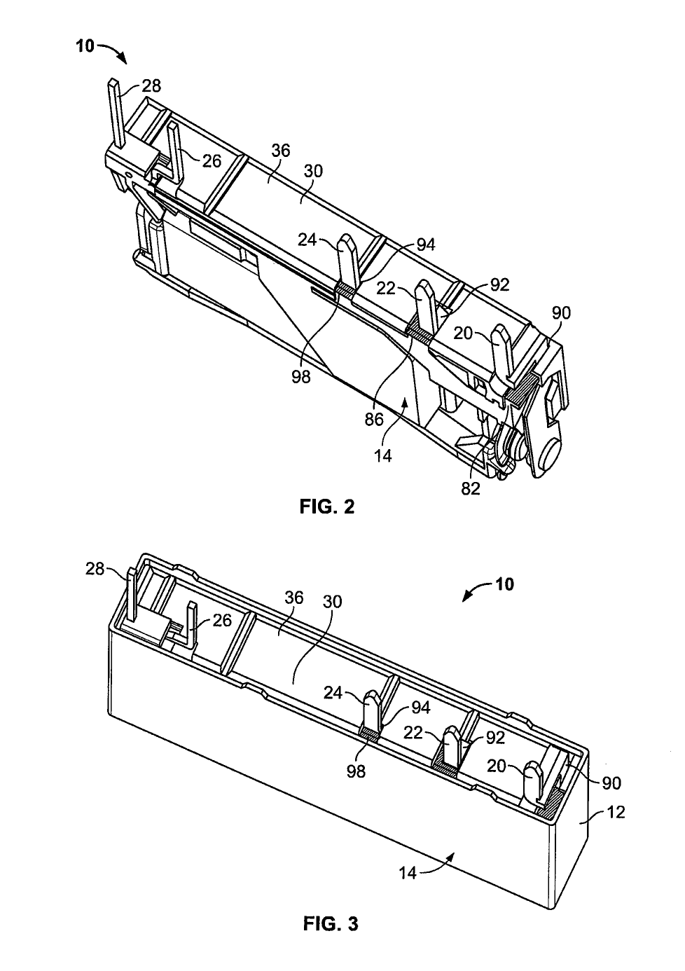

As shown in FIGS. 2-3 ends (shown in hatched lines) of the webs 82, 86 and the tongue 98 of the insertion member 80 facing the connection side 30 together with the connection pins 20, 22, 24 substantially completely seal the slots 90, 92, 94 in the connection side 30 of the main body 36. The edge adjoining the connection side 30 of the main body 36 in this case interlocks with the hood 12 or rests thereon. The opening in the hood 12 is thus completely sealed by the main body 36, the connection pins 20, 22, 24 and the insertion member 80.

Because the second contact carrier 42 is elastically deformable, the contacts 50, 52, 54, 56 have different switching states. In a first switching state or idle state, the contact 54 of the second contact carrier 42 rests against the contact 56 (break contact) of the third contact carrier 44, which is connected to the connection pin 24. At the same time, the contact 52 of the second contact carrier 42 is spatially distanced from the contact 50 (make contact) of the first contact carrier 40, which is connected to the connection pin 20. Therefore, in the first switching state, the connection pins 22, 24 are electrically conductive. On the other hand, the connection pins 20, 22 are electrically insulated from one another.

In a second switching state or operating state, the contact 52 of the second contact carrier 42 rests against the contact 50 (make contacts) of the first contact carrier 40, which is connected to the connection pin 20. At the same time, the contact 54 of the second contact carrier 42 is spatially distanced from the contact 56 (break contact) of the third contact carrier 44, which is connected to the connection pin 24. Therefore in the second switching state, the connection pins 20, 22 are electrically conductive. On the other hand, the connection pins 22, 24 are electrically insulated from one another.

The magnetic system 46 is connected to the second contact carrier 42 via a mechanical transmission element 58. If the magnetic system 46 is not energized, the first switching state applies, and if the magnetic system 46 is energized, the second switching state applies. The magnetic system 46 is connected to connection pins 26, 28, which protrude from the connection side 30 of the relay 10. The magnetic system 46 can be supplied with a control or excitation current through the connection pins 26, 28.

To assemble the relay 10, the connection pins 20, 22, 24 are introduced into the slots 90, 92, 94 from the assembly side 14 with a movement substantially perpendicular to the assembly side 14, substantially perpendicular to longitudinal axes of the connection pins 20, 22, 24, and substantially parallel to the connection side 30. The first, second, and third contact carriers 40, 42, 44 are connected to the connection pins 20, 22, 24 either directly or via conductor elements (not shown), which may be configured integrally with the connection pins 20, 22, 24, before the connection pins 20, 22, 24 are inserted into the slots 90, 92, 94. Alternatively, the first, second, and third contact carriers 40, 42, 44 may be integrally formed with the connection pins 20, 22, 24.

The insertion member 80 is then introduced into the main body 36 from the assembly side 14 with a movement substantially perpendicular to the assembly side 14 and substantially parallel to the connection side 30. In so doing, the web 72 of the main body 36 engages between the webs 82, 84 of the insertion member 80 to extend the leakage path between the connection pin 20 and the first contact carrier 40 on the one hand and between the connection pin 22 and the second contact carrier 42 on the other hand. The web 86 of the insertion member 80 engages between the second contact carrier 42 and the connection pin 22 on the one hand and between the web 74 on the main body 36 on the other hand such that the webs 74, 86 are located between the connection pin 22 and the second contact carrier 42 on the one hand and the connection pin 24 and the third contact carrier 44 on the other hand. Consequently, the leakage path between these elements is substantially S-shaped and is particularly long. The web 88 of the insertion member 80 engages between the web 76 of the main body 36 and the magnetic system 46.

As shown in FIG. 1, the end of the magnetic system 46 facing the first, second, and third contact carriers 40, 42, 44 is inserted into the main body 36. Three layers consisting of the electrically insulating materials of the main body 36 and the insertion member 80 are thus located between the connection pin 24 and the third contact carrier 44 on the one hand and between the magnetic system 46 on the other hand. This meets the requirement of minimizing the total distance between the first, second, and third contact carriers 40, 42, 44 and the magnetic system 46.

The insertion member 80 with the webs 82, 84, 86, 88 thus lengthens all relevant leakage paths in a substantially S-shape and accordingly allows the relay 10 to be miniaturized more extensively. Another factor which contributes to improving the insulation, in addition to the lengthening of the leakage paths, is that when the webs 72, 74, 76, 82, 84, 86, 88 are in direct contact with one another, the formation of conductive deposits is prevented or at least minimized.

As shown in FIG. 3, the main body 30 inserted into the hood 12 is set back slightly with respect to the edge of the hood 12 to form a substantially tank-shaped recess. The recess may be readily filled initially with liquid sealant, such as an adhesive, without the sealant being able to penetrate inside the relay 10. The sealant is then cured, for example by a heat treatment, so that it hermetically seals the relay 10. This permanently prevents gas, dust, or other contaminants from penetrating into the relay 10 to ensure a long relay service life.

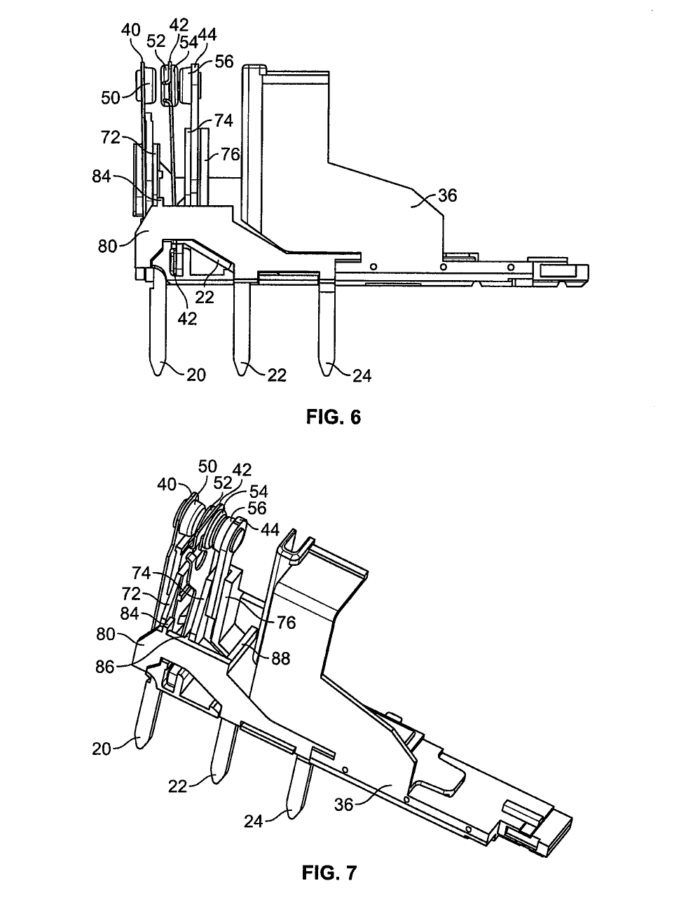

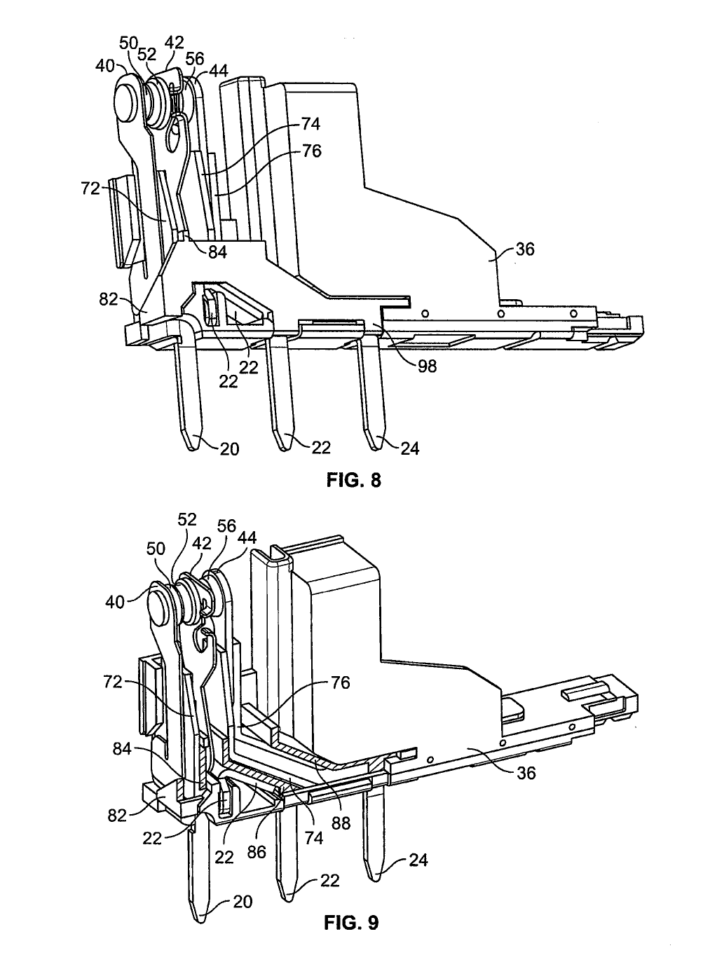

FIGS. 6-11 show the relay 10 according to a second embodiment of the invention. The relay 10 according to the second embodiment differs from the relay 10 according to the first embodiment in that the main body 36 in an area of the magnetic system 46 and in a vicinity of the first contact carrier 40 and the insertion member 80 in the vicinity of the first contact carrier 40 are shaped differently. However, these differences do not affect the basic principle of the present invention.

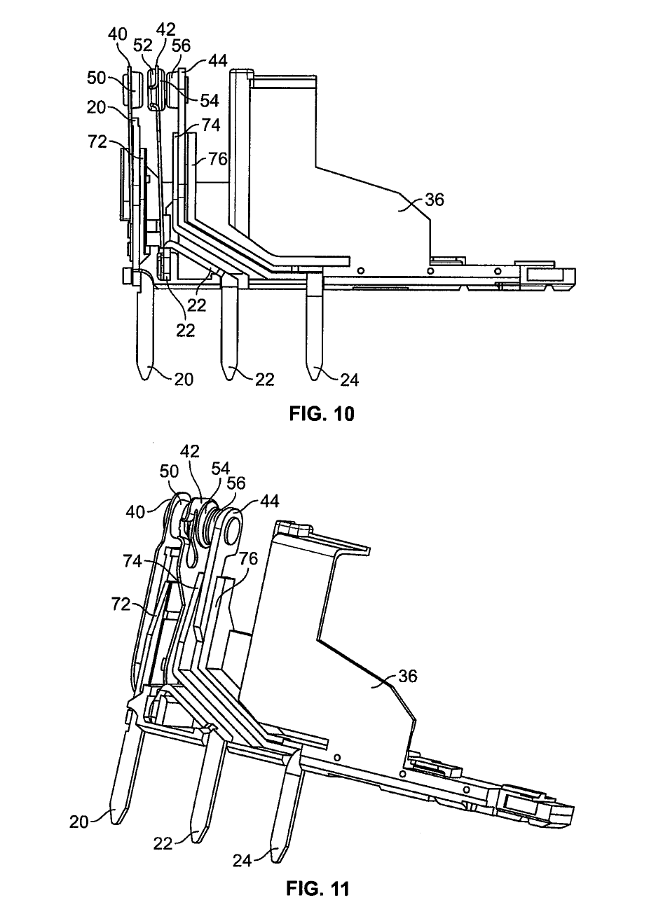

FIGS. 6-11 show the relay 10 without the hood 12, the magnetic system 46 or the mechanical transmission element 58. Further, FIG. 9 shows the insertion member 80 partly cut open with vertical cut surfaces (parallel to the assembly side 14) being illustrated in diagonally hatched lines. FIGS. 10-11 show the main body 36 with the first, second, and third contact carriers 40, 42, 44 and the connection pins 20, 22, 24, but without the insertion member 80. The viewing direction in FIGS. 6 and 10 is substantially perpendicular to the assembly side 14.

As shown in FIGS. 6 and 10, the connection pin 24 is formed integrally with the third contact carrier 44, for example from a stamped and curved metal sheet, while the first and second contact carriers 40, 42 are made, for example, of a resilient material which is thinner than that of the connection pins 20, 22, 24 and of the third contact carrier 44. The first and second contact carriers 40, 42 are conductively connected to the connection pins 20, 22 inside the relay 10 by, for example, riveting, soldering, welding or by another connection method. In so doing, an upper end of the connection pin 20 inside the relay 10 forms a stop for the first contact carrier 40, thereby ensuring a minimum distance between the contact 56 (break contact) and the contact 50 (make contact). The resilience of the first contact carrier 40 serves to restrict the contact force between the contacts 50, 52.

In the embodiments represented above, the insertion member 80 seals the slots 90, 92, 94 in the main body 36 that have not already been sealed by the connection pins 20, 22, 24 and at the same time lengthens the leakage paths via the webs 84, 86, 88 to improve electrical insulation. Alternatively, the insertion member 80 may only serve to close the slots 90, 92, 94 if sufficiently long leakage paths are ensured by other measures, or the insertion member 80 may only serve to lengthen the leakage paths if the slots 90, 92, 94 do not have to be sealed or are sealed by a different measure. For example, it may be possible to configure the connection pins 20, 22, 24 directly on the edge of the connection surface 30 and to make the slots 90, 92, 94 small enough to be completely sealed by the connection pins 20, 22, 24.

If it is unnecessary to seal the slots 90, 92, 94 or if sealing is ensured by other measures and sufficiently long leakage paths or an effective electrical insulation is ensured by other measures, it is possible to dispense with the insertion member 80. Merely the lateral introduction of the connection pins 20, 22, 24 into the main body 36 provides a clear simplification and a corresponding reduction in production costs compared to the conventional encapsulation by injection molding or casting of the connection pins 20, 22, 24 into the main body 36. Furthermore, it is possible for the insertion member 80 to seal only a part of the slots 90, 92, 94 and/or to lengthen only individual leakage paths by the webs 82, 84, 86, 88.

It is obvious that the present invention does not depend on the number of the contacts 50, 52, 54, 56, the first, second, and third contact carriers 40, 42, 44, the connection pins 20, 22, 24, or the switching states. If the relay 10 has a plurality of connectors, circuit breakers or change-over switches for separate circuits, it is advantageous to provide a second insertion member 80, in which case, for example, each insertion member is provided for the connection pins 20, 22, 24 and the first, second, and third contact carriers 40, 42, 44 of a switch. In this case, the attachment members are preferably introduced into the main body 36 from opposite sides.

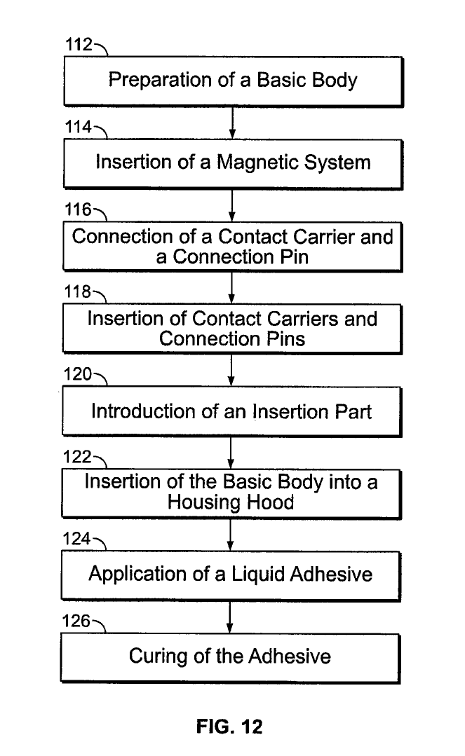

FIG. 12 is a schematic flow chart of a method of production of the relay 10 according to the invention. As shown in FIG. 12, in a first step 112, the main body 36 is prepared. In a second step 114, the magnetic system 46 is introduced into the main body 36 by inserting the magnetic system 46 into the main body 36 in a direction substantially parallel to the assembly side 14 and the connection side 30. In a third step 116, the first, second, and third contact carriers 40, 42, 44 and the connection pins 20, 22, 24 are interconnected in pairs directly or via the conductor element (not shown), unless already integrally formed therewith. In a fourth step 118, the first, second, and third contact carriers 40, 42, 44 and the connection pins 20, 22, 24 are inserted into the main body 36 and into the slots 90, 92, 94 from the assembly side 14 by a movement substantially perpendicular to the assembly side 14 and substantially parallel to the connection side 30 (transversely to the connection pins 20, 22, 24 longitudinal axis).

In a fifth step 120, the insertion member 80 is inserted into the main body 36 from the assembly side 14 by a movement substantially perpendicular to the assembly side 14 and substantially parallel to the connection side 30. This measure seals the slot 90, 92, 94, as discribed above, and/or lengthens leakage paths by the webs 82, 84, 86, 88 on the insertion member 80. In a sixth step 122, the main body 36 with the assembled connection pins 20, 22, 24, the first, second, and third contact carriers 40, 42, 44, the inserted insertion member 80, the assembled magnetic system 46, and the transmission element 58 are introduced into the hood 12. In this case, the edge, adjoining the connection side 30 of the main body 36 is substantially interlocking with the hood 12. In a seventh step 124, an initially liquid adhesive or another liquid sealant is applied in a preferably two-dimensional manner to the connection side 30 of the main body 36, which is not covered by the hood 12. In an eighth step 126, the sealant is cured, for example, under the effect of light or heat, so that the hood 12 is hermetically sealed.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A relay, comprising:
a main body containing first, second, and third contact carriers, connection pins, and a magnetic system;
the first, second, and third contact carriers provided with contacts, each of the first, second, and third contact carriers being connected to at least one of the connection pins, the connection pins protruding outward from a connection side of the relay;
the magnetic system mechanically coupled to at least one of the first, second and third contact carriers for changing switching states of the contacts; and
an insertion member arranged adjacent to the connection side, the insertion member having a plurality of webs, one of the webs of the insertion member being positioned between each of the first, second, and third carrier contacts.

2. The relay of claim 1, wherein one of the webs of the insertion member is positioned between the first, second, and third contact carriers and the magnetic system.

3. The relay of claim 1, wherein the main body includes webs, each of the webs of the main body being positioned between the webs of the insertion member and in engagement therewith.

4. The relay of claim 1, wherein the connection pins protrude from slots in the connection side, the slots being partly sealed by the connection pins and partly sealed by the webs of the insertion member.

5. The relay of claim 4, wherein the slots extend from an assembly side adjoining the connection side, the insertion member being introduced into the main body from the assembly side.

6. The relay of claim 1, wherein leakage paths between the connection elements and the first, second, and third contact carriers are substantially S-shaped.

7. The relay of claim 1, further comprising a hood having an opening exposing the connection side of the relay.

8. The relay of claim 1, wherein the insertion member is introduced into the main body from an assembly side adjoining the connection side.

9. The relay of claim 1, wherein the first, second, and third contact carriers are formed of a resilient material, the resilient material of the first and second contact carriers being thinner than the resilient material of the third contact carrier.

10. A method for producing a relay, comprising the steps of:
inserting a magnetic system into a main body;
inserting first, second, and third contact carriers into the main body, the first, second, and third contact carriers being provided with contacts;
inserting connection pins into the main body so that the connection pins protrude outward from a connection side of the relay, each of the first, second, and third contact carriers being connected to at least one of the connection pins; and
introducing an insertion member into the main body from an assembly side adjoining the connection side, the insertion member having webs positioned between each of the first, second, and third carrier contacts.

11. The method of claim 10, wherein the connection side includes a plurality of slots extending from the assembly side, the connection pins being inserted into the slots from the assembly side with a movement substantially perpendicular to the assembly side and substantially parallel to the connection side.

12. The method of claim 11, further comprising the step of sealing the slots with the insertion member.

13. The method of claim 10, wherein the insertion member is introduced into the main body by a movement substantially perpendicular to the assembly side and substantially parallel to the connection side.

14. The method of claim 10, further comprising the step of inserting the main body into an opening in a hood such that the connection side is exposed by the opening.

15. The method of claim 14, further comprising the step of sealing the opening in the hood with a liquid adhesive.

16. The method of claim 10, wherein the main body includes webs, each of the webs of the main body being positioned between the webs of the insertion member and in engagement therewith.

17. The method of claim 10, wherein leakage paths between the connection elements and the first, second, and third contact carriers are substantially S-shaped.

18. The method of claim 10, wherein the first, second, and third contact carriers are formed of a resilient material, the resilient material of the first and second contact carriers being thinner than the resilient material of the third contact carrier
